(19) United States
(12) Patent Application Publication
(10) Pub. No.: US 2026/0307711 A1
(43) Pub. Date: Oct. 8, 2026

(54) A SELF-CENTRING MECHANISM AND HANDWHEEL ACTUATOR FOR A STEER-BY-WIRE SYSTEM

(71) Applicant: Chassis Autonomy SBA AB, Trollhättan (SE)

(72) Inventor: Kristoffer Jidetoft, Trollhättan (SE)

(21) Appl. No.: 19/485,121

(22) PCT Filed: May 23, 2024
(86) PCT No.: PCT/SE2024/050501

§ 371 Date: Nov. 17, 2025

(30) Foreign Application Priority Data
May 25, 2023 (SE) 2330236-7

(51) Int. Cl. B62D 5/00; B62D 1/10

(52) U.S. Cl. CPC B62D 5/005; B62D 1/10

(57) ABSTRACT

A self-aligning mechanism for a steer-by-wire system, comprises a steering wheel armature mounted on a steering column shaft with a rotation limited to less than 180° in a first rotation direction and a second rotation direction from an armature centre position. The mechanism also includes a guide profile mounted to the steering column shaft and a returning force mechanism configured to generate a returning force against the guide profile, as the rotation of the steering wheel armature from the armature centre position increases. This self-aligning mechanism provides improved steering control and safety in steer-by-wire systems.

### CROSS REFERENCE TO RELATED APPLICATIONS

This application claims priority to International Application No. PCT/SE2024/050501, filed May 23, 2024, which claims priority to Sweden Application No. 2330236-7 filed May 25, 2023, the contents of both of which are incorporated herein by reference in their entirety.

### FIELD

The technology relates to the field of automotive engineering, specifically to steering systems for vehicles, and in particular steer-by-wire systems.

### BACKGROUND

Steer-by-wire systems have been developed as an alternative to traditional mechanical steering systems in vehicles. In a traditional mechanical steering system, the steering wheel is directly connected to the wheels of the vehicle through a series of mechanical linkages, which allows the driver to control the direction of the vehicle. A feature of a mechanical steering system is its natural tendency to self-centre, meaning that when the driver releases the steering wheel, the vehicle will generally continue to travel in a straight line. This self-centring characteristic is achieved through the design of the suspension and steering system components.

In contrast, a steer-by-wire system eliminates the mechanical linkages between the steering wheel and the wheels of the vehicle. Instead, the steering wheel is connected to an electronic control unit (ECU) and a motor, which in turn controls the direction of the wheels. While steer-by-wire systems offer several advantages, such as reduced weight and increased design flexibility, they also present challenges in terms of providing the self-centring characteristic required by legal regulations for passenger vehicles.

Several solutions have been proposed to address the lack of self-centring in steer-by-wire systems. Some of these solutions involve modifying the design of the electronic feedback control system to simulate the self-centring effect. However, these solutions may not be suitable for all types of vehicles and may require complex tuning and calibration processes. Additionally, in the event of a loss of feedback control, there is no natural self-centring mechanism of the steering wheel, since it is not connected to the wheels.

Therefore, there is a need for an improved self-aligning mechanism for steer-by-wire systems that can provide the required self-centring characteristic.

### SUMMARY

In a first aspect, the disclosure provides a self-aligning mechanism for a steer-by-wire system. The self-aligning mechanism includes a steering wheel armature mounted on a steering column shaft with a rotation limited to less than 180° in a first rotation direction and a second rotation direction from an armature centre position. The mechanism also includes a geometry mounted to the steering column shaft and a returning force mechanism configured to generate a returning force against the geometry, as the rotation of the steering wheel armature from the armature centre position increases.

In some examples, the steering wheel armature has a rotation limited to between 90° and 150° in the first rotation direction and the second rotation direction from the centre position.

The geometry may comprise a smallest radii at a geometry centre position and an increasing radii towards a geometry end position.

The geometry can also include a symmetric arcuate guide profile.

The returning force mechanism may comprise a roller bearing configured to move in a direction towards or away from an axis of rotation of the steering wheel armature.

The roller bearing can be mounted on a centre guide post attached to the steering wheel armature.

The roller bearing may be selected from the group consisting of a ball bearing, a sleeve bearing, and a tapered roller bearing.

In some examples, the self-aligning mechanism further includes a preloaded spring configured to generate torque on the steering wheel armature towards a centre position stop.

The preloaded spring can be selected from the group consisting of a compression coil spring and a tension coil spring.

The steering wheel armature may comprise at least one spoke mounted to the steering column shaft.

The at least one spoke can include a spoke central recess extending along a longitudinal axis of the spoke and configured to house the returning force mechanism.

The spoke central recess may be configured to receive a roller bearing that moves within the recess along the spoke longitudinal axis as the geometry moves with respect to the spoke.

In some examples, the geometry further includes a centre position stop having a central recess configured to receive the roller bearing when the steering wheel armature is in the armature centre position.

The geometry can be tuneable for different vehicle chassis and steering wheel mass/inertia.

Optionally, the return force generated by the return force mechanism is constant as the radius of the geometry increases from a geometry centre position towards a geometry end position.

In a second aspect, the disclosure provides a hand wheel actuator comprising the self-aligning mechanism as described above.

In a third aspect of the disclosure, there is a method of using the self-aligning mechanism according to the first aspect, the method comprising: a) mounting a steering wheel armature on the steering column shaft wherein the steering wheel armature is rotatable less than 180° in a first rotation direction and a second rotation direction from an armature centre position; b) mounting a geometry around the steering column shaft; assembling a roller bearing operatively coupled to a preloaded spring in a guide housing; and d) engaging the roller bearing with the geometry and generating a self-centring torque when the steering wheel armature rotates from an armature centre position.

### BRIEF DESCRIPTION OF THE DRAWINGS

The disclosure will now be described in more detail with reference to the accompanying drawings, in which:

FIG. 1 is a perspective view of steering armature according to an example;

FIG. 2 is a schematic front view of the steering armature in different positions according to an example;

FIG. 3 is a cross-sectional view of the self-aligning mechanism in an armature centre position according to an example;

FIG. 4 is a cross-sectional view of the self-aligning mechanism in another position according to an example;

FIG. 5 is a perspective cross-sectional view of the self-aligning mechanism and steering wheel armature according to an example;

FIG. 6 is a close-up perspective view of the self-aligning mechanism according to an example;

FIG. 7 is a close-up perspective view of the self-aligning mechanism according to an example;

FIG. 8 is a close-up perspective view of the self-aligning mechanism according to an example; and

FIG. 9 is a side view of the self-aligning mechanism according to an example.

### DETAILED DESCRIPTION

The present disclosure will now be described in detail with reference to various examples. It should be understood that these examples are provided for illustrative purposes only and are not intended to limit the scope of the present disclosure.

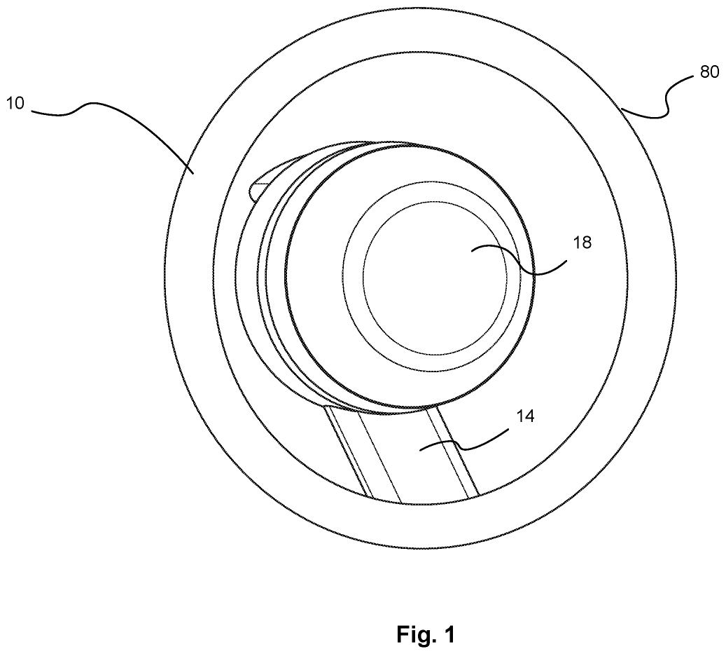

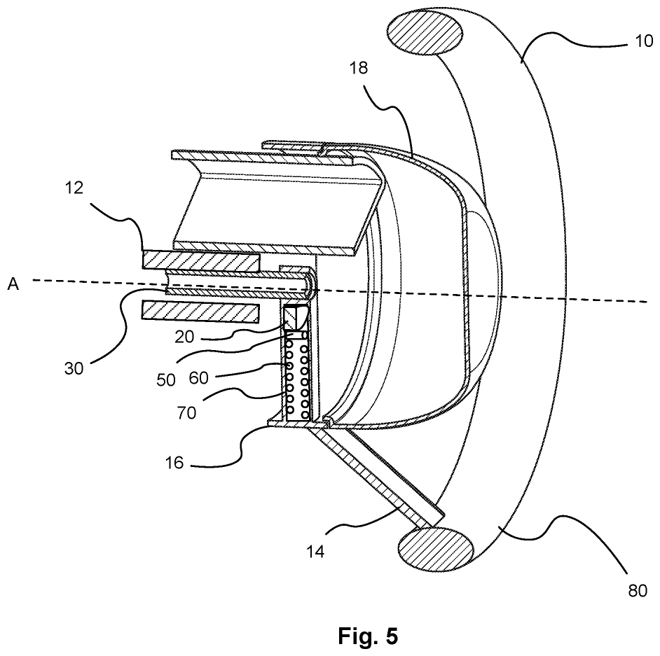

FIG. 1 is a perspective view of a handwheel actuator comprising a steering wheel armature 10 according to an example. The steering wheel armature 10 is mounted on a steering column shaft 30 (best shown in FIG. 5). FIG. 5 shows a perspective cross-sectional view of a self-aligning mechanism 100 and steering wheel armature 10 according to an example.

The steering wheel armature 10 has a rotation limited to less than 180° in a first rotation direction and a second rotation direction from an armature centre position. This limited rotation range provides a more controlled and precise steering experience for the user, ensuring that the steering wheel does not rotate excessively and cause potential safety hazards.

The hand wheel actuator also includes a steering wheel armature 10 having at least one spoke 70 mounted to the steering column shaft 30. In some examples the at least one spoke 70 is a single spoke 70 which is mounted to the steering column shaft 30.

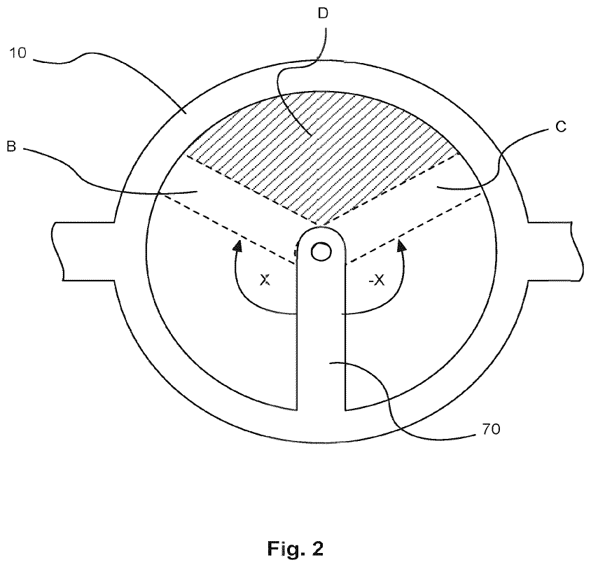

The at least one spoke 70 is rotatable from a first spoke position B (best shown in FIG. 2) to a second spoke position C (also best shown in FIG. 2). FIG. 2 shows a schematic view of the steering wheel armature 10. In some examples, an electrical component (not shown) optionally protrudes through the steering wheel armature 10 and is fixed with respect to the steering column 12. The electrical component (not shown) is positioned outside the range of movement of the at least one spoke 70.

The range of movement of the at least one spoke 70 is best shown in FIG. 2. As mentioned above, the at least one spoke 70 is rotatable from a first spoke position B to a second spoke position C. In FIG. 2, the steering wheel armature 10 is positioned in an armature centre position. In order to rotate the at least one spoke 70 to the first spoke position B, the steering wheel armature 10 rotates through an angle of X degrees. In order to rotate the at least one spoke 70 to the second spoke position C, the steering wheel armature 10 rotates through an angle of-X degrees.

The steering column 12 serves as the primary structural component that supports the steering wheel armature 10 and connects it to the vehicle. As mentioned above, the steering column 12 comprises a steering column shaft 30. The steering column shaft 30 is rotatable about a steering column axis A-A and rotatably mounted within the steering column 12. The steering column shaft 30 is operatively coupled to the steering actuator and rotates when the steering wheel armature 10 rotates.

In some examples, the steering column 12 and steering column shaft 30 are designed to integrate with steer-by-wire technology. Steer-by-wire technology eliminates the need for a mechanical connection between the steering wheel armature 10 and the steering mechanism. Instead, the mechanical connection is replaced with an electronic system that transmits steering inputs from the steering wheel armature 10 to the vehicle's steering mechanism. This electronic system may comprise various sensors, actuators, and control units that work together to provide precise and responsive steering control.

The integration of steer-by-wire technology into the steering column 12 and steering column shaft 30 allows for a more compact and lightweight design, as well as increased flexibility in the positioning and orientation of the steering wheel armature 10 within the vehicle's cabin. Additionally, the use of electronic components in the steering system enables advanced features and functionalities, such as customizable steering feel, adaptive steering assistance, and improved safety features.

In particular, an advantage of a steer-by-wire steering assembly, is that the physical decoupling of the steering wheel armature 10 from the steering actuator of the steering mechanism means that the steering wheel armature 10 does not need to turn more than 180 degrees in either rotational direction of the steering wheel armature 10. As described below, the steering wheel armature 10 rotates through only a portion of a turn in either direction.

Accordingly, in some examples at least one spoke 70 is rotatable from a first spoke position B to a second spoke position C and the at least one spoke 70 does not rotate beyond the first spoke position B and the second spoke position C. A static portion D of the hand wheel actuator is shown in FIG. 2. The at least one spoke 70 is configured not to rotate through the static portion D.

The static portion D as shown in FIG. 2 is at the top of the steering wheel armature 10 and the spoke 70 is located at a 6 o'clock position when the steering wheel armature 10 is in an armature centre position. Alternatively, the static portion D is at the bottom of the steering wheel armature 10 and the spoke 70 is located at a 12 o'clock position when the steering wheel armature 10 is in an armature centre position.

In some examples, the steering wheel armature 10 is rotatable less than 180 degrees in a first rotation direction and a second rotation direction from a central position. The first rotation direction and the second rotation direction are respectively indicated in FIG. 2 with the angular displacement X, −X.

In some examples, the range of motion of the steering wheel armature 10 may be between 90 degrees and 150 degrees in the first rotation direction and between 90 degrees and 150 degrees in the second rotation direction. In some other examples, the range of motion of the steering wheel armature 10 may be ±90 degrees, ±100 degrees, ±110 degrees, ±120 degrees, ±130 degrees, ±140 degrees, ±150 degrees. As shown in FIG. 2, the range of motion of the steering wheel armature 10 is optionally ±120 degrees. This leaves approximately a segment of 120 degrees of the static portion D of the hand wheel actuator. This range of motion limitation ensures smooth and consistent movement throughout the range, minimal play or slack in movement, low resistance and effort required for movement, adequate tactile feedback to the driver, and reliable and durable mechanism operation.

In other examples the static portion D comprises a sector of a circle having an angle of 5 degrees, 10 degrees, 15 degrees, 20 degrees, 25 degrees, 30 degrees, 35 degrees, 40 degrees, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, 120 degrees, 125 degrees, 130 degrees, 135 degrees, 140 degrees, 145 degrees or 150 degrees.

In some examples, the steering wheel armature 10 has a rotation limited to between 90 degrees and 150 degrees in the first rotation direction and the second rotation direction from the centre position. This specific range of rotation allows for a balance between the user's ability to make sharp turns and the prevention of oversteering, which could lead to loss of control of the vehicle. The armature centre position serves as a reference point for the steering wheel armature 10 rotation, ensuring that the user can easily return the steering wheel armature 10 to its neutral position after making a turn.

In one example, the steering wheel armature 10 is rotatable in both a first rotation direction and a second rotation direction as indicated by the arrows X, −X in FIG. 2. This allows the user to steer the vehicle in both left and right directions, providing a versatile and adaptable steering experience. The first and second rotation directions may be clockwise and anticlockwise, respectively, or vice versa, depending on the specific design and orientation of the steering wheel armature 10 and the steering column shaft 30.

In some examples, the steering wheel armature 10 may comprise a rim 80 with a surface for gripping by the user.

In some examples, the steering wheel armature 10 may comprise a plurality of spokes 70 for increased support and stability.

In one example, the steering wheel armature 10 comprises the rim 80 mounted to the steering column shaft 30 via the at least one spoke 70. The rim 80 is connected to the at least one spoke 70 via at least one outer spoke 14. The outer spoke 14 is connected to an inner ring 16 which is connected to the at least one spoke 70. The rim 80 is configured to provide a surface for a driver to grip onto. The rim 80 allows the driver to comfortably and securely hold the steering wheel armature 10 while driving. The design and features of the rim 80 can vary as required. In some examples a steering wheel cover 18 is mounted on the inner ring 16. The steering wheel cover 18 is best shown in FIG. 5.

The rim 80 as shown in the Figures e.g., FIG. 1 is generally circular. The circular shape of the steering wheel armature 10 is exemplary and not essential to the hand wheel actuator. However, in other examples, the steering wheel armature 10 can comprise other shapes, such as square, hexagon or any other suitable shape. Indeed, in some other examples, the steering wheel armature 10 can be a yoke-type steering wheel armature 10.

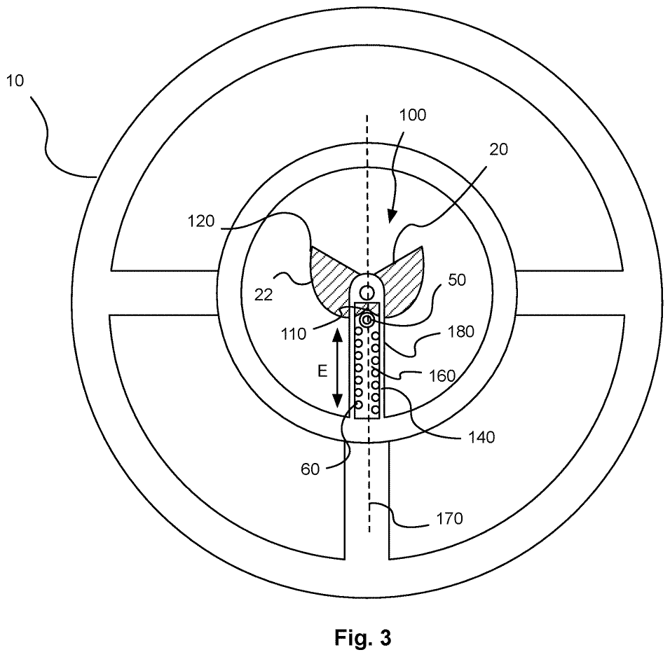

In order to allow the steering wheel armature 10 to return to an armature centre position, the hand wheel actuator comprises a self-aligning mechanism 100. The self-aligning mechanism 100 is shown in FIG. 3. FIG. 3 shows a cross-sectional view of the self-aligning mechanism 100 in an armature centre position.

In one example, the self-aligning mechanism 100 comprises a geometry 20. The geometry 20 is mounted around the steering column shaft 30 and is configured to interact with the returning force mechanism 180 to generate a returning force against the geometry 20. This returning force is generated as the rotation of the steering wheel armature 10 from the armature centre position increases. In this way, the self-aligning mechanism 100 exerts a self-centring torque on the steering wheel armature 10. The geometry 20 is an component mounted to the steering wheel armature 10 which has a surface with varying height and the returning force mechanism 180 engages the surface. The geometry 20 can also be known as a guide profile 22.

The geometry 20 is fixed with respect to the steering column axis A-A. Accordingly, the geometry 20 does not rotate when the steering column shaft 30 and the steering wheel armature 10 rotate.

In some examples, the geometry 20 comprises a smallest radii at a geometry centre position 110 and an increasing radii towards a geometry end position 120. This design allows for a smooth and continuous generation in the returning force as the steering wheel armature 10 rotates away from the armature centre position. The smallest radius at the geometry centre position 110 ensures that the returning force is minimized when the steering wheel armature 10 is near the armature centre position, providing a stable and comfortable resting position for the steering wheel.

In one example, the geometry 20 may comprise a symmetric arcuate guide profile 22 that extends between the geometry centre position 110 and the geometry end position 120. This symmetric arcuate guide profile 22 ensures that the returning force generated by the returning force mechanism 180 is consistent and predictable in both the first rotation direction and the second rotation direction. This consistency in the returning force provides a more intuitive and natural steering experience for the driver.

In some examples, the geometry 20 is designed with a spiral cross-section that varies in radius from the geometry centre position 110 to the geometry end position 120. This radii variation allows for a continuous and smooth generation in the returning force as the steering wheel armature 10 rotates away from the armature centre position. The symmetric arcuate guide profile 22 ensures that the returning force is consistent and predictable in both the first rotation direction and the second rotation direction, providing a more intuitive and natural steering experience for the driver.

The geometry 20 may be mounted around the steering column shaft 30 using various methods. In some examples, the geometry 20 may be fixed with respect to the steering column 12, but ensuring that the geometry 20 remains stationary as the steering wheel armature 10 rotates around the steering column axis A-A.

The geometry 20 and its mounting to the steering column shaft 30 provide several advantages for the self-aligning mechanism 100 in a steer-by-wire system. The geometry 20 allows for a smooth and continuous generation in the returning force as the steering wheel armature 10 rotates away from the armature centre position, providing a more intuitive and natural steering experience for the driver. The fixed mounting of the geometry 20 to the steering column shaft 30 ensures that the returning force is consistent and predictable throughout the entire range of rotation of the steering wheel armature 10, further enhancing the steering experience. Additionally, the geometry 20 may be tuneable for different vehicle chassis and steering wheel mass/inertia, allowing for customization and optimization of the self-aligning mechanism 100 for various vehicle applications.

As mentioned above, in some examples, the self-aligning mechanism 100 for a steer-by-wire system comprises a returning force mechanism 180 that is configured to generate a returning force against the geometry 20. The returning force is generated as the rotation of the steering wheel armature 10 from the armature centre position increases, providing a self-centring torque to the steering wheel armature 10 and ensuring that the steering wheel returns to its centre position when not in use or when the user releases the steering wheel. The returning force mechanism 180 is configured to urge against the guide profile 22 in order to generate a returning force on the steering wheel armature 10. This means that the steering wheel armature 10 returns back to a centre position as a result of the returning force mechanism 180 urging against the guide profile 22.

In one example, the returning force mechanism 180 may comprise a roller bearing 50 that is configured to move in a direction E (as shown in FIG. 3) towards or away from the steering column axis A-A. The roller bearing 50 engages and rolls along on the profile 22 of the geometry 20. The movement of the roller bearing 50 is governed by the varying radii of the geometry 20 as the steering wheel armature 10 rotates. This movement of the roller bearing 50 generates the returning force against the geometry 20, which in turn creates the self-centring torque on the steering wheel armature 10.

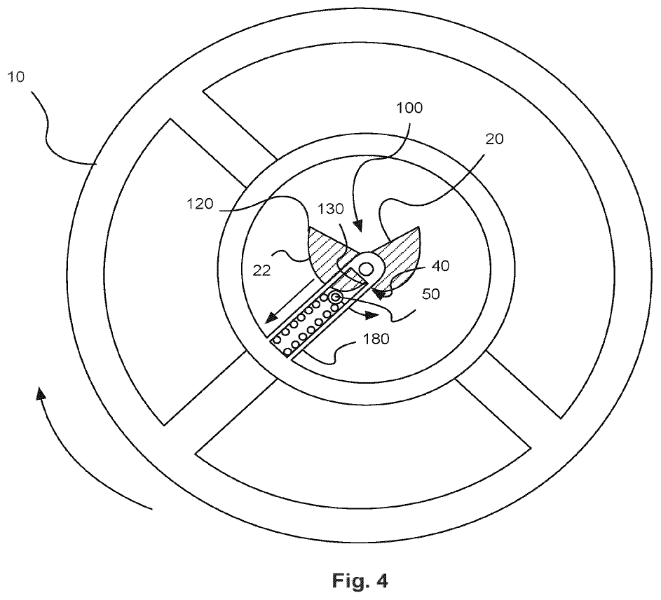

FIG. 4 shows the same arrangement as shown in FIG. 3 except that the steering wheel armature 10 has rotated with respect to the steering column axis A-A. In this case, the roller bearing 50 has been forced against the returning force mechanism 180 which is generating a returning force on the geometry 20.

In some examples, the roller bearing 50 may be replaced from any other suitable bearing. For example, the roller bearing 50 can be replaced with one or more of a ball bearing, a sleeve bearing, or a tapered roller bearing. Each of these bearing types offers different advantages in terms of load capacity, friction, and durability, allowing for the customization of the self-aligning mechanism 100 to suit the specific requirements of the steer-by-wire system and the vehicle in which it is installed. In some examples, the roller bearing 50 is optionally omitted and an end surface of returning force mechanism 180 engages and urges against the guide profile 22. In some examples, the end surface can comprise a low friction coating.

In one example, the roller bearing 50 may be mounted on a guide housing 140 that is attached to the steering wheel armature 10. The guide housing 140 is configured to hold a preloaded spring 60 and the roller bearing 50 in line with the steering column axis A-A, ensuring that the returning force mechanism 180 operates smoothly and efficiently. In some examples, the guide housing 140 is integral with the spoke 70.

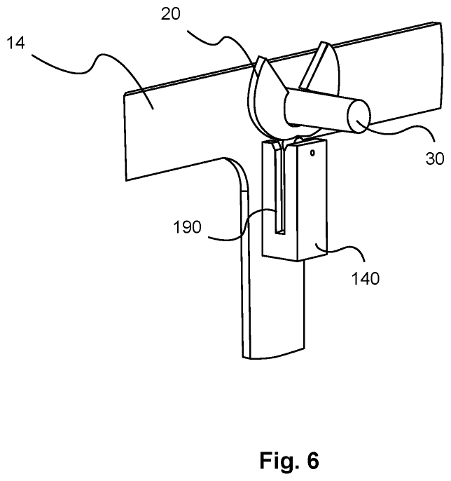

In some other examples, the guide housing 140 is separate from the spoke 70. For example as shown in FIGS. 6 to 9, the guide housing 140 and the self-aligning mechanism 100 may optionally house the returning force mechanism 180 separate from the spoke 70. This arrangement may provide additional design flexibility and simplify the assembly process.

In one example, the returning force mechanism 180 may further comprise a preloaded spring 60 that is configured to generate torque on the steering wheel armature 10 towards a centre position stop 40. The preloaded spring 60 works in conjunction with the roller bearing 50 to create the self-centring torque, ensuring that the steering wheel armature 10 returns to the armature centre position when not in use or when the user releases the steering wheel armature 10. This feature is particularly important in the event of feedback control failure, as it provides a fail-safe mechanism to maintain vehicle stability and control.

In some examples, the preloaded spring 60 may be a compression coil spring or a tension coil spring. Alternatively, any other suitable spring type can be used for the preloaded spring 60. Both types of springs offer different advantages in terms of load capacity, spring rate, and durability, allowing for the customization of the self-aligning mechanism 100 to suit the specific requirements of the steer-by-wire system and the vehicle in which it is installed. The choice of spring type may also depend on the design of the steering wheel armature 10 and the geometry 20, as well as the desired level of self-centring torque and the overall performance characteristics of the steer-by-wire system. In some examples, a preloaded spring 60 is not used. Instead, another component can be used to urge the returning force mechanism 180 against the guide profile e.g. a rubber block, a pneumatic piston etc. In some examples, the preloaded spring 60 is not preloaded and the spring is only loaded when the steering wheel armature 10 rotates.

As shown in FIGS. 3, 4 and 5, in some examples, the at least one spoke 70 may comprise a spoke central recess (160) extending along a spoke longitudinal axis 170. The spoke central recess 160 may be configured to house the returning force mechanism 180, which includes the roller bearing 50 and the preloaded spring 60. By housing the returning force mechanism 180 within the spoke central recess 160, the overall design of the steering wheel armature 10 may be more compact and streamlined, reducing the overall size and weight of the self-aligning mechanism 100.

The spoke central recess 160 may also provide protection for the returning force mechanism 180 from external contaminants, such as dust, dirt, and moisture, which could potentially interfere with the proper functioning of the returning force mechanism 180. Additionally, the spoke central recess 160 may help to reduce noise generated by the returning force mechanism 180 during operation, providing a quieter and more comfortable driving experience for the user.

In some examples, the spoke central recess 160 is configured to receive a roller bearing 50 that moves within the recess along the spoke longitudinal axis 170 as the geometry 20 moves with respect to the spoke 70. This movement is illustrated in FIGS. 3 and 4. This movement of the roller bearing 50 within the spoke central recess 160 allows for the generation of the returning force against the geometry 20 as the steering wheel armature 10 rotates in either the first rotation direction or the second rotation direction.

The movement of the roller bearing 50 within the spoke central recess 160 may be facilitated by a low-friction surface or a lubricant applied to the interior of the spoke central recess 160. This may help to ensure smooth and consistent movement of the roller bearing 50 within the spoke central recess 160, providing a reliable and predictable self-centring force for the steering wheel armature 10.

In some examples, the geometry 20 of the self-aligning mechanism 100 may comprise a centre position stop 40 that is designed to provide a reference point for the steering wheel armature 10 when it is in the armature centre position. The centre position stop 40 can be an integral part of the geometry 20 or may be a separate component that is attached to or interacts with the geometry 20. The centre position stop 40 can provide a stable and reliable reference point for the steering wheel armature 10 to return to its centre position, ensuring proper alignment and control of the steer-by-wire system.

In some examples, the centre position stop 40 may include a central recess 130 which is formed by the two symmetric parts of the geometry 20 meeting. This forms the central recess 130 which provides positive feedback to the user when the steering wheel armature 10 is in the armature centre position. The central recess 130 is configured to receive the roller bearing 50 when the steering wheel armature 10 is in the armature centre position. The central recess 130 is designed to accommodate the roller bearing 50, allowing it to move smoothly within the recess as the steering wheel armature 10 rotates and the geometry 20 moves with respect to the spoke 70.

The engagement of the roller bearing 50 within the central recess 130 at the armature centre position ensures that the returning force mechanism 180 generates the minimum returning force against the geometry 20, thereby providing a stable and consistent reference point for the steering wheel armature 10. This engagement also contributes to the overall self-centring torque generated by the self-aligning mechanism 100, as the returning force against the geometry 20 is generated as the rotation of the steering wheel armature 10 from the armature centre position increases.

The central recess 130 may be designed with a specific shape and size to accommodate various types of roller bearings 50, such as ball bearings, sleeve bearings, and tapered roller bearings. This flexibility in design allows for the self-aligning mechanism 100 to be adaptable to different steering systems and vehicle chassis, providing a versatile solution for generating self-centring torque in a steer-by-wire system.

In some examples, the geometry 20 may be tuneable for different vehicle chassis and steering wheel mass/inertia, allowing for the self-aligning mechanism 100 to be customized according to specific vehicle requirements. This tunability ensures that the self-aligning mechanism 100 provides the optimal self-centring torque for a given vehicle, enhancing the overall steering experience for the driver.

In some examples, the geometry 20 of the self-aligning mechanism 100 may be designed and configured to be tuneable for different vehicle chassis and steering wheel mass/inertia. This tunability allows for the self-aligning mechanism 100 to be adaptable and versatile, providing optimal performance and self-centring torque for a wide range of vehicle types and steering wheel designs.

In one example, the geometry 20 may be designed with varying radii and arcuate guide profile 22 profiles to accommodate different vehicle chassis and steering wheel mass/inertia requirements. The geometry 20 may be configured to have a smallest radii at the geometry centre position 110 and an increasing radii towards the geometry end position 120, as previously described. The specific radii values and the rate at which the radii increase towards the geometry end position 120 may be adjusted and optimized for different vehicle chassis and steering wheel mass/inertia.

In some examples, the returning force mechanism 180 may be adjusted to provide the appropriate returning force for different vehicle chassis and steering wheel mass/inertia. This may include selecting different types of roller bearings 50, such as ball bearings, sleeve bearings, or tapered roller bearings, as well as adjusting the preloaded spring 60. The preloaded spring 60 may be selected from a group consisting of compression coil springs and tension coil springs, with varying spring constants and preloading values to generate the desired self-centring torque for the specific vehicle chassis and steering wheel mass/inertia.

In some examples the preloaded spring 60 comprises a linear spring constant. This means that the returning force generated is dependent on the amount that the preloaded spring 60 is compressed. If the profile 22 of the geometry 20 increases linearly as a function of the angular displacement, then the returning force will be constant as the steering wheel armature 10 is rotated with respect to the geometry 20. In some other examples, the returning force exerted by the returning force mechanism 180 is not constant. For example, the returning force increases as the rotation of the steering wheel armature 10 from the armature centre position increases. In this case, the preloaded spring 60 may have a non-linear spring rate. For example, the returning force generated with a small displacement of the roller bearing 50 is less than the returning force generated with a large displacement of the roller bearing 50.

In some other examples, the returning force generated by the returning force mechanism 180 can be adjusted with the profile 22 of the geometry 20. For example, the radius of the profile 22 can increase non-linearly as a function of the angular displacement. This means that the roller bearing 50 and the preloaded spring 60 will compress at different rates depending on the position of the steering wheel armature 10 with respect to the geometry 20. The profile 22 of the geometry 20 can be tuned as described below.

The tunability of the geometry 20 and the returning force mechanism 180 provides several advantages for the self-aligning mechanism 100 in a steer-by-wire system. First, it allows for the self-aligning mechanism 100 to be adaptable to a wide range of vehicle types and steering wheel designs, ensuring optimal performance and self-centring torque for each specific application. This adaptability can lead to improved steering feel and driver confidence, as well as increased safety and reliability in the event of feedback control failure.

Second, the tuneable geometry 20 and returning force mechanism 180 can help to reduce the overall complexity and cost of the steer-by-wire system by allowing for a single self-aligning mechanism 100 design to be used across multiple vehicle platforms and steering wheel designs. This can lead to economies of scale and reduced manufacturing costs, as well as simplified inventory management and maintenance for vehicle manufacturers and service providers.

In summary, the tunability of the geometry 20 and the returning force mechanism 180 in the self-aligning mechanism 100 for a steer-by-wire system provides a versatile and adaptable solution for generating self-centring torque across a wide range of vehicle chassis and steering wheel mass/inertia. This adaptability ensures optimal performance, improved steering feel, and increased safety and reliability for various vehicle types and steering wheel designs, while also reducing complexity and cost for vehicle manufacturers and service providers.

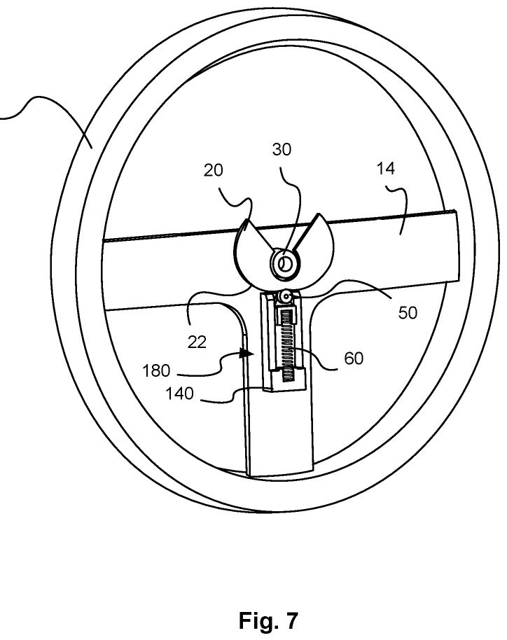

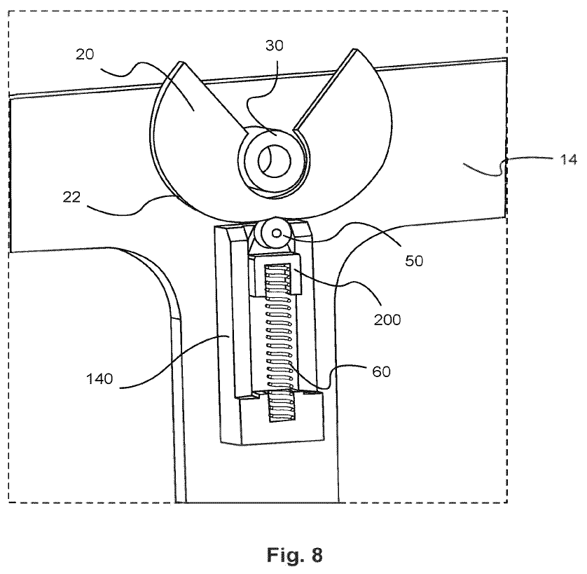

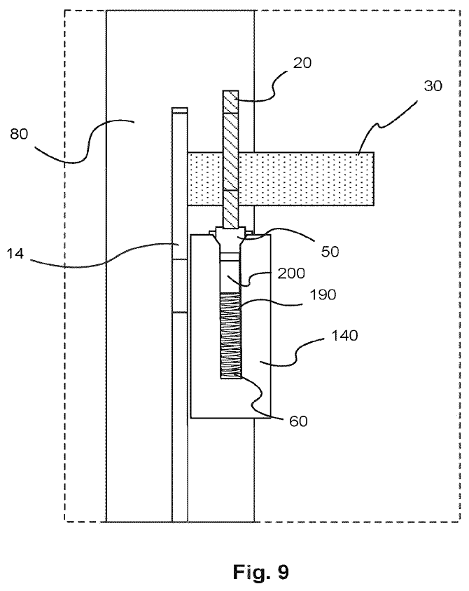

Reference will now be made to FIGS. 6, 7, 8 and 9. FIG. 6 is a close-up perspective view of the self-aligning mechanism 100 according to an example. FIG. 7 is a close-up perspective view of the self-aligning mechanism 100 according to an example. FIG. 8 is a close-up perspective view of the self-aligning mechanism 100 according to an example. FIG. 9 is a side view of the self-aligning mechanism 100 according to an example.

The self-aligning mechanism 100 is the same as shown in reference to the previous Figures except that the self-aligning mechanism 100 is not part of the spoke 70. Instead, the self-aligning mechanism 100 is mounted on the steering wheel armature 10.

FIG. 6 shows part of the outer spokes 14 of the steering wheel armature 10. The guide housing 140 is mounted on the steering wheel armature 10. The guide housing 140 comprises a geometry slot 190 configured to receive the geometry 20 as the steering wheel armature 10 and the guide housing 140 rotate with respect to the geometry 20. Similar to the previous examples, the geometry 20 is fixed with respect to the steering column axis A-A.

FIGS. 7 and 8 shows the self-aligning mechanism 100 mounted on the steering wheel armature 10. FIG. 7 also shows the guide housing 140 partially cutaway. Here the returning force mechanism 180 is visible. The returning force mechanism 180 functions in the same way as previously discussed.

In some examples the roller bearing 50 is rotatably mounted on a moveable carriage 200. The movable carriage 200 is configured to slide within the guide housing 140 as the geometry 20 enters the geometry slot 190 and the profile 22 of the geometry 20 engages the roller bearing 50.

When the user lets go of the steering wheel armature 10, the preloaded spring 60 will act via the roller bearing 50 creating a returning torque which brings the steering wheel armature 10 back to armature centre position.

The exact shape of the profile 22 in some examples is tuned so that the behaviour of the return force is predictable and safe. The steering wheel armature 10 is controlled with a motor and ECU when everything is working normally. However, if there is a failure the self-aligning mechanism 100 provides a physical feedback mechanism in the event of a failure.

In another example, two or more examples are combined. Features of one example can be combined with features of other examples.

Examples of the present disclosure have been discussed with particular reference to the examples illustrated. However, it will be appreciated that variations and modifications may be made to the examples described within the scope of the disclosure.

1. A self-aligning mechanism for a steer-by-wire system, comprising:
a steering wheel armature mounted on steering column shaft having a rotation limited to less than 180° in a first rotation direction and a second rotation direction from an armature centre position, wherein the steering wheel armature has:
a guide profile mounted around the steering column shaft; and
a returning force mechanism configured to urge against the guide profile to generate a returning force against the guide profile when the rotation of the steering wheel armature from the armature centre position increases.

2. The self-aligning mechanism according to claim 1, wherein the steering wheel armature has a rotation limited to between 90° and 150° in the first rotation direction and the second rotation direction from the centre position.

3. The self-aligning mechanism according to claim 1, wherein the guide profile comprises a smallest radii at a geometry centre position and an increasing radii towards a geometry end position

4. The self-aligning mechanism according to of claim 1, wherein the guide profile comprises a symmetric arcuate guide profile (22).

5. The self-aligning mechanism according to of claim 1, wherein the returning force mechanism comprises a roller bearing configured to move in a direction towards or away from an axis of rotation of the steering wheel armature.

6. The self-aligning mechanism according to claim 5, wherein the roller bearing is mounted on a guide housing attached to the steering wheel armature.

7. The self-aligning mechanism according to of claim 5, wherein the roller bearing is selected from the group consisting of a ball bearing, a sleeve bearing, and a tapered roller bearing.

8. The self-aligning mechanism according to of claim 1, further comprising a preloaded spring configured to generate torque on the steering wheel armature towards a centre position stop.

9. The self-aligning mechanism according to claim 8, wherein the preloaded spring is selected from the group consisting of a compression coil spring and a tension coil spring.

10. The self-aligning mechanism according to of claim 1 to wherein the steering wheel armature comprises at least one spoke mounted to the steering column shaft.

11. The self-aligning mechanism according to claim 10, wherein the at least one spoke comprises a spoke central recess extending along a spoke longitudinal axis and configured to house the returning force mechanism.

12. The self-aligning mechanism according to claim 11, wherein the spoke central recess is configured to receive a roller bearing that moves within the recess along the spoke longitudinal axis as the guide profile moves with respect to the spoke.

13. The self-aligning mechanism according to of claim 1, to wherein the guide profile further comprises a centre position stop having an central recess configured to receive the roller bearing when the steering wheel armature is in the armature centre position.

14. The self-aligning mechanism according to of claim 1, wherein the guide profile is replaceable with another guide profile having a different shape configured for a different vehicle chassis and/or steering wheel mass/inertia.

15. The self-aligning mechanism according to of claim 1, wherein the return force generated by the return force mechanism constant as the radius of the guide profile increases from a geometry centre position towards a geometry end position.

16. A hand wheel actuator comprises the self-aligning mechanism according to claims

17. A method of using the self-aligning mechanism according to claim 1, in a steer-by-wire system, the method comprising:
a) mounting a steering wheel armature on the steering column shaft wherein the steering wheel armature is rotatable less than 180° in a first rotation direction and a second rotation direction from an armature centre position;
b) mounting a guide profile around the steering column shaft;
c) assembling a roller bearing operatively coupled to a preloaded spring in a guide housing in the steering wheel armature; and
d) engaging the roller bearing with the guide profile and generating a self-centring torque when the steering wheel armature rotates from an armature centre position.
